(19) United States
(12) Patent Application Publication
(10) Pub. No.: US 2012/0221789 A1
(43) Pub. Date: Aug. 30, 2012

(54) Specifying Physical Attributes of a Cloud Storage Device

(75) Inventor: Wesley M. Felter, Austin, TX (US)

(73) Assignee: INTERNATIONAL BUSINESS MACHINES CORPORATION, Armonk, NY (US)

(21) Appl. No.: 13/465,463

(22) Filed: May 7, 2012

Related U.S. Application Data
(63) Continuation of application No. 13/007,173, filed on Jan. 14, 2011.

(51) Int. Cl. G06F 12/00

(52) U.S. Cl. 711/114; 711/154; 711/E12.001

(57) ABSTRACT

Mechanisms are provided for creating a cloud storage device. A user interface is presented for selecting a type of physical storage devices, from a plurality of possible physical storage devices, to include in the cloud storage device and a quantity of a selected type of physical storage devices to include in the cloud storage device. User input is received via the interface specifying the selected type of physical storage devices and the quantity of the selected type of physical storage devices. A cloud storage device is generated comprising the specified quantity of the selected type of physical storage devices. The cloud storage device is presented for access by a client computing device associated with the user.

### BACKGROUND

The present application relates generally to an improved data processing apparatus and method and more specifically to mechanisms for specifying physical attributes of a cloud storage device.

Cloud computing refers to the providing of computing services and resources over the Internet, where the “cloud” refers to the graphical depiction of the Internet in technical diagrams. As opposed to traditional services provided via networks, a cloud computing service is typically sold on demand, is flexible (a user can have as much of the service as they require at a time of the user's choosing), and is fully managed by the provider such that the user needs nothing but a computing device that can access the Internet.

Cloud computing services are generally divided into infrastructure-as-a-service, platform-as-a-service, and software-as-a-service categories. Infrastructure-as-a-service typically provides server instances with unique IP addresses and blocks of storage on demand. Customers may use the providers application program interface (API) to start, stop, access and configure their virtual servers and storage. In an enterprise, cloud computing allows a company to pay for only as much capacity as is needed, and bring more capacity online as soon as it is required. Because this pay-for-what-you-use model resembles the way electricity, fuel, and water are consumed, it is sometimes referred to as utility computing.

Platform-as-a-service in cloud computing is defined as a set of software and product development tools hosted on a provider's infrastructure. Developers create applications on the provider's platform over the Internet. Software-as-a-service in cloud computing involves a vendor supplying the hardware infrastructure and the software product, with the user interacting with the software product via a front-end portal. Services can be anything from Web-based electronic mail to inventory control and database processing. Because the service provider hosts both the application and the data, the user is able to access the service from anywhere using an Internet connection.

One type of infrastructure-as-a-service category of cloud computing is cloud storage. Cloud storage refers to the providing of a virtual storage device as a service via the Internet. A user specifies how much storage capacity the user requires and a virtual storage device of the requested capacity size is created by the cloud storage host system. The actual physical storage devices that are utilized to provide the amount of storage capacity requested by the user are selected by the cloud storage host system and may vary in physical and operating characteristics, neither of which are able to be chosen by the end user. Thus, the end user only sees a single virtualized storage device accessible via the Internet, however the single virtualized storage device is comprised of a plurality of physical storage devices of various types and operating capabilities that may be physically present in a plurality of different computing systems and may even be physically and geographically remotely located from each other.

Thus, with cloud storage as it currently exists, the end user is not given any information or control over the physical storage devices that are used to provide the requested storage capacity. This leaves the end user with little or no control over performance or price/performance/reliability tradeoffs.

### SUMMARY

In one illustrative embodiment, a method, in a data processing system, is provided for creating a cloud storage device. The method comprises presenting a user interface for selecting a type of physical storage devices, from a plurality of possible physical storage devices, to include in the cloud storage device and a quantity of a selected type of physical storage devices to include in the cloud storage device. The method further comprises receiving user input via the interface specifying the selected type of physical storage devices and the quantity of the selected type of physical storage devices. Moreover, the method comprises generating a cloud storage device comprising the specified quantity of the selected type of physical storage devices. In addition, the method comprises providing the cloud storage device for access by a client computing device associated with the user.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a pictorial representation of an example distributed data processing system in which aspects of the illustrative embodiments may be implemented;

FIG. 2 is a block diagram of an example data processing system is shown in which aspects of the illustrative embodiments may be implemented;

FIG. 3 is an example block diagram of a cloud storage service system in accordance with one illustrative embodiment;

FIG. 4 is an example diagram of a user interface for selecting physical disks to be included in a cloud storage device in accordance with one illustrative embodiment; and

FIG. 5 is a flowchart outlining an example operation for establishing a cloud storage device in accordance with one illustrative embodiment.

### DETAILED DESCRIPTION

The illustrative embodiments provide mechanisms for specifying physical attributes of a cloud storage device. The illustrative embodiments define a cloud storage device, and provide a cloud storage service, in terms of disks having a guaranteed and predictable performance. That is, a user (or customer) requests a cloud storage device comprised of a particular number of hard disks of a standardized type, e.g., standardized storage capacity, performance, etc. The user is given information about the types of hard disks from which they may select including their capacity and performance information. The user may then select which type of disk the user wishes to include in their cloud storage device and the number of such disks. From this selection, the cloud storage service composes one or more storage arrays built from the specified number of disks and a specified RAID level. One or more pools of disks are then built out of a set of storage arrays using configurable RAID parameters (e.g., type and stripe width). The pool of disks stores volumes and filesystems for use by the end user (or customer).

Using these mechanisms, users/customers are able to trade off price, performance, and reliability and optimize their cloud storage for their workload by choosing different RAID parameters. The mechanisms of the illustrative embodiments further provide predictable performance since each customer has a dedicated set of disks. That is, contrary to current cloud storage services which host multiple customers on the same physical disks, with the mechanisms of the illustrative embodiments, since the customer pays per disk, only that single customer is able to utilize the disk and it is not shared amongst a plurality of customers. Thus, the customer is able to rely on predictable performance with regard to the storage disks associated with that customer.

It should be appreciated that while the present description will refer to the cloud storage device being comprises of hard disks, or simply “disks,” the illustrative embodiments are not limited to hard disks as the physical storage devices that comprise the cloud storage device. To the contrary, other types of physical storage devices, e.g., magnetic tape, solid state memory, and the like, may be used without departing from the spirit and scope of the illustrative embodiments.

As will be appreciated by one skilled in the art, the aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

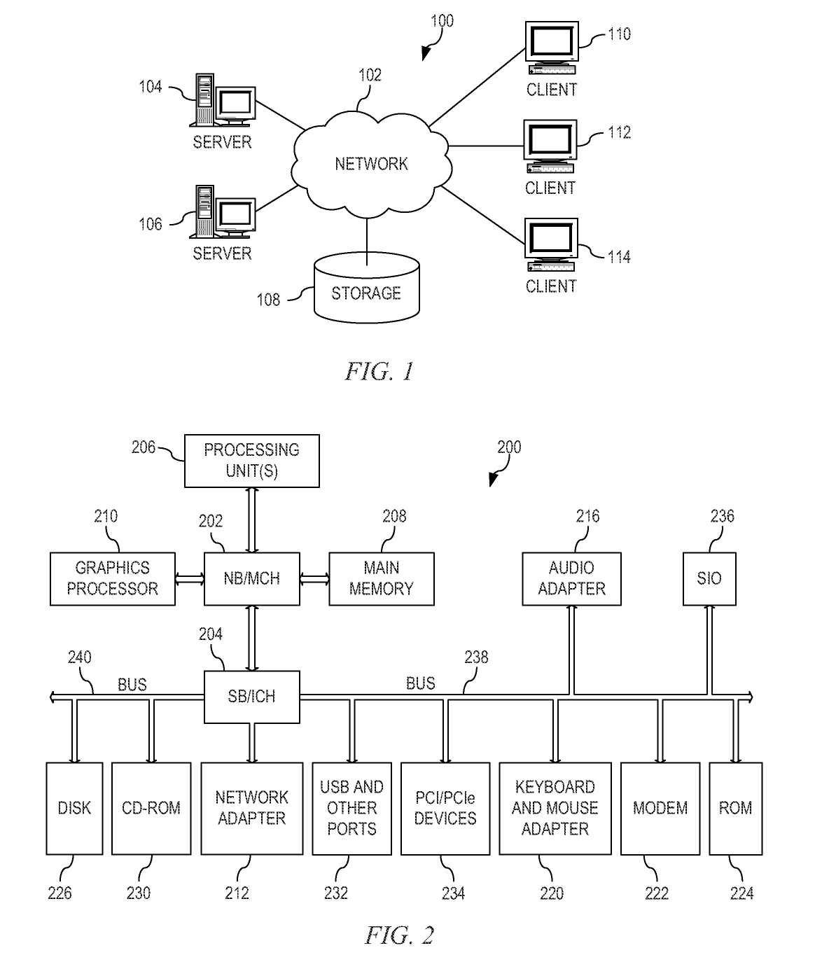

The illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® 7 (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Oracle and/or its affiliates in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

With reference again to FIG. 1, one or more of the server computing devices, e.g., server 104 and/or 106, may provide a cloud storage service by having cloud storage service applications executing on one or more processors of the servers 104 and/or 106. The servers 104 and/or 106 may have associated storage devices, such as network attached storage unit 108 or the like, from which individual disks, disk drives, or the like, may be selected for use with individual customer's cloud storage devices generated via the cloud storage service.

The cloud storage service provided by the cloud storage service applications executing on one or more of the servers 104 and/or 106 provide functionality for allowing a user (customer) to select disk types to be including in a user's cloud storage device. The cloud storage service further provides functionality for compiling a pool of disks of the type selected by the user that together provide a designated amount of storage capacity. The pool of disks is comprised of a set of storage arrays, which in turn are comprised of a specified number of disks, of the type selected by the user, arranged according to a specified RAID level. The cloud storage service is further responsible for automatically swapping out failed disks and replacing them with replacement disks of a same type.

When a physical disk is associated with a particular user (customer) pool of disks, the physical disk is assigned to that user such that no other users' data is stored on that physical disk. In other words, there is a one-to-one mapping between physical disks and users/customers. As a result, the user's access to the physical disk, and thus the physical disk's performance, may be guaranteed. That is, there will not be any other users' data on the physical disk and thus, there will not be any other users' attempting to access the physical disk at a same time as the user to which it is assigned. Thus, no other users are able to degraded the performance of the physical disk. Even in a storage system where there are multiple physical disks with some being used by one user and others being used by another user, performance is not degraded if separate controllers are used for the different disks, or subsets of disks.

In addition, the cloud storage service includes a billing system which tracks and generates billing information for each user (customer) based on their respective contractual arrangements. These contractual arrangements, in one illustrative embodiment, involve billing the user based on an amount of money per disk per time period, e.g., $1.00 per disk per day where a customer using 5 disks would pay $5.00 per day for the cloud storage service. Thus, the customer may be billed on a per disk, or per physical storage device, basis rather than simply on a per time period or per unit of capacity basis.

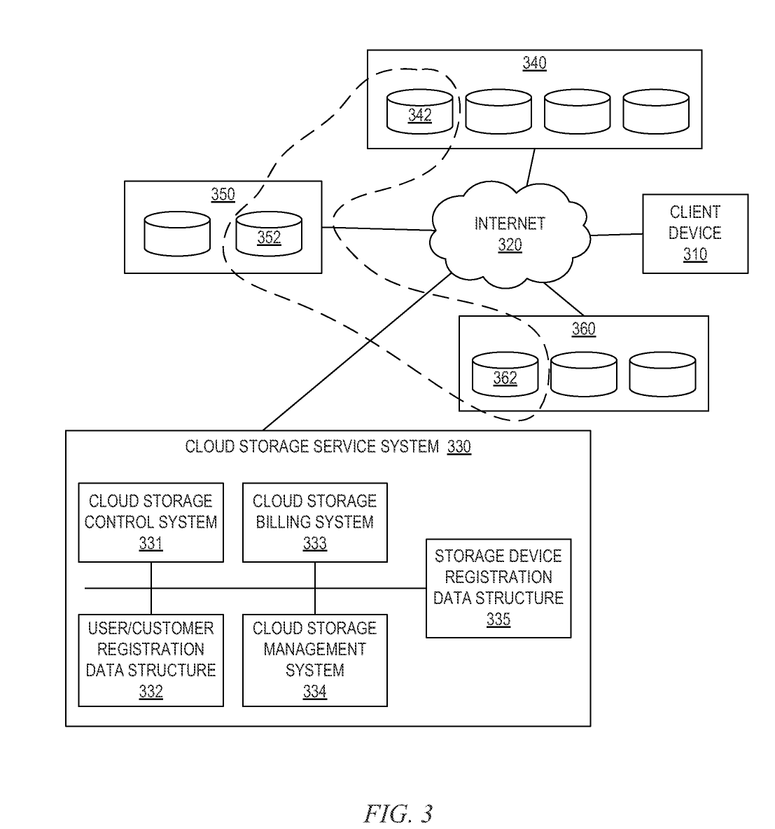

FIG. 3 is an example block diagram of a cloud storage service system in accordance with one illustrative embodiment. As shown in FIG. 3, the cloud storage service system 330 includes a cloud storage control system 331, a user/customer registration data structure 332, a cloud storage billing system 333, a cloud storage management system 334, and a storage device registration data structure 335. These elements 331-335 may be implemented as software, hardware, or any combination of software and hardware. For example, in one illustrative embodiment, the elements 331, 333, and 334 may be implemented as software executing on one or more processors of the server computing device 330. Elements 332 and 335 may be implemented as data constructs in one or more storage devices, e.g., memory, hard disks, or the like, of the server computing device 330. The elements 331-335 may interface with each other through a data communications mechanism (not show), such as a bus or the like, so that the elements 331-335 may work in conjunction with each other to provide cloud storage services to users/customers accessing the server 330 via a client computing device 310 and the data network 320, which in the depicted example is the Internet.

The cloud storage control system 331 provides the logic for interfacing with a user/customer to accept user input regarding the cloud storage device that the user wishes to establish and further provides the logic for generating and managing the resulting cloud storage device and the physical storage devices that together constitute the cloud storage device, as described hereafter. The user/customer registration data structure 332 stores data corresponding to the users/customers and the particular cloud storage devices associated with the users/customers.

The cloud storage billing system 333 generates billing information for the user/customer according to the particular cloud storage device associated with the user/customer and the usage of the cloud storage device by the user/customer. The cloud storage failover system 334 monitors the health of the various cloud storage devices managed by the cloud storage system and the physical storage devices that are part of the cloud storage devices such that failover of failed physical storage devices may be performed. The storage device registration data structure 332 stores data regarding the available physical storage devices that may be assigned by the cloud storage system as well as the assignment of physical storage devices when they are assigned to user/customer cloud storage devices.

With these mechanisms in place, a user of a client computing device 310 may communicate with the server 330 via the data network (Internet) 320 in order to utilize the cloud storage service provided by the server 330. The cloud storage control system 331 responds to the client computing device 310 by providing one or more Web pages, user interfaces, applets, or the like, through which the user is able to interface with the cloud storage system of the server 330 to thereby establish a cloud storage device, i.e. a virtual hard disk with which the client computing device 310 may interact to store and retrieve data. For example, the user of the client computing device 310 may be presented with web pages explaining the contractual terms, conditions, etc. that will govern an arrangement between the user and the provider of the cloud computing system. In addition, user interfaces, Web page forms, or the like, may be provided for gathering information from the user regarding contact information, billing information, and the like. Most importantly, the user interfaces, Web pages, or the like may present options to the user for the types of storage devices, e.g., hard disks, that the user can choose to be part of their cloud storage device, a RAID level to be used with the cloud storage device, and the like. In the context of the present description, a type of storage device represents a combination of a storage capacity of the storage device and one or more performance characteristics of the storage device, e.g., revolutions per minute (RPMs), throughput (e.g., MB/s), I/O operations per second (IOPS), or the like.

The storage devices from which a user may select have standardized types such that a user may select from a set of pre-established standardized types of storage devices rather than having many different storage devices of various performance and size which are assigned to the user's cloud storage device without regard to the user's desire for particular minimum performance requirements. That is, the user may be presented with various options of standardized types of storage devices, e.g., hard drives of 1 TB in size operating at 7200 RPMs, hard drives of 500 GB operating at 10000 RPMs, hard drives of 250 GB operating at 15000 RPMs, solid state storage devices, or the like. Each type of storage device may have a different associated licensing or rental fee associated with it on a per device and per time period basis, i.e. $X/disk/hour (or other time period, day, month, year, etc.). For example, hard drives of larger storage capacity and/or higher operating performance may have a higher associated licensing fee associated with them than a hard drive of smaller storage capacity and/or lower operating performance. Moreover, different technology storage devices may have different associated licensing fees, e.g., solid state storage devices may have a relatively higher licensing fee than hard drives, which may have a higher licensing fee than tape drives, and the like.

The user may select a number of a particular type of hard drive that the user wishes to include in their cloud storage device based on the user's own subjective determination of a desired tradeoff between cost, storage capacity, and performance. For example, the user may select disks of 1 TB in size with a performance of 7200 RPMs because the user values the storage capacity and performance and determines that the associated cost set by the cloud storage service provider is reasonable for the storage capacity and performance. Further, based on the user's required storage capacity, the user may select 3 of these types of disks because the user requires 3 TB of storage capacity for their cloud storage device.

It should be noted that while the illustrative embodiments are described in terms of the user selecting disks of a same type for inclusion in the cloud storage device, the illustrative embodiments are not limited to such. Rather, the user may select more than one type of physical storage device to be included in the cloud storage device if desired. For example, there may be disks of different storage capacity that have the same performance characteristics, e.g., a 500 GB disk operating at 7200 RPMs and a 1 TB disk operating at 7200 RPMS, both of which may be included in the cloud storage device with the ability to guarantee a desired level of performance.

In addition to the above, the user may be presented with options with regard to reliability of the cloud storage device from which the user may select the reliability mechanisms the user wishes to employ with the cloud storage device. For example, the user may be presented with a plurality of RAID levels that the user may select from. For example, there currently exists 6 RAID levels from which a user may select, with each RAID level providing a different level of reliability. For example, with RAID 0 (also known as a stripe set or striped volume) data is split evenly across two or more disks (striped) with no parity information for redundancy. For RAID 1, an exact copy of a set of data, or a mirror, is generated on two or more disks. For RAID 5 uses block-level striping with parity data distributed across all member disks.

There may be different licensing costs associated with each type of reliability option and these licensing costs are presented to the user so that the user may perform a subjective tradeoff between cost and reliability. Thus, with the mechanisms of the illustrative embodiments, rather than only providing the user with an option of specifying a storage capacity of a cloud storage device and then not ensuring any amount of performance, as is done in current systems, the user is presented with options for specifying the types and numbers of disks that the user wishes to include in their cloud storage device, where the type is defined by a storage capacity of the disk and one or more performance characteristics of the disk, such that the user may define the storage capacity and performance of their cloud storage device. In addition, the user can specify a reliability level for their cloud storage device. As a result, the user is presented with more control over the performance and reliability of their cloud storage device.

The particular options of the types of storage devices from which the user may select, as well as the number of each type of storage device may be dependent upon availability of the various types of storage devices as specified in the storage device registration data structure 335. The cloud storage management system 334 is responsible for monitoring the operating state of all of the physical storage devices maintained by the cloud storage service provider and to affect failover when necessary. The cloud storage management system 334 may determine what physical storage devices are available in the global pool of physical storage devices and may maintain information about each physical storage device in the storage device registration data structure 335. Thus, if new physical storage devices are added to the global pool, the cloud storage management system 334 adds entries to the storage device registration data structure 335 to represent these new physical storage devices. As the state of the physical storage devices changes, the cloud storage management system 334 updates the corresponding entries in the storage device registration data structure 335. For example, if a physical storage device is removed, then its corresponding entry is deleted from the storage device registration data structure 335. If a physical storage device is determined to have failed, then a status indicator in its corresponding entry in the storage device registration data structure 335 is updated to reflect that the physical storage device has failed and is not available for inclusion in cloud storage devices. If a physical storage device has been added to a user's cloud storage device, then an identifier of the user's cloud storage device is included in the entry of the physical storage device such that the physical storage device cannot then be assigned to another cloud storage device until it is freed.

The user's selections, via the various user interfaces, Web page forms, applets, or the like, are transmitted to the cloud storage control system 331 which interacts with the user/customer registration data structure 332 and cloud storage billing system 333 to establish an account for the user and generate billing information to be used to bill the user for the particular types and numbers of physical storage devices selected by the user as well as the reliability mechanisms selected by the user to be used in their cloud storage device. Information regarding the user and his/her account may be stored in the user/customer registration data structure 332 along with billing information.

The cloud storage control system 331 may interact with the storage device registration data structure 335 to select a number of physical storage devices corresponding to the number and type selected by the user, for inclusion in a cloud storage device for the user. The corresponding entries in the storage device registration data structure 335 may then be marked with an identifier of the user's cloud storage device so that they may be associated with that particular user's cloud storage device exclusively, i.e. these physical storage devices cannot be shared with other users' cloud storage devices. This helps to ensure predictability of performance and a guarantee that the user will receive the desired level of performance from the user's cloud storage device.

The cloud storage control system 331 may then create the cloud storage device using the selected physical storage devices, meeting the type and performance criteria selected by the user. The creation of the cloud storage device is performed in a manner generally known in the art. For example, the selected physical storage devices are associated with one or more logical storage arrays that are built from the specified number of physical storage devices selected by the user, having the selected performance. The one or more storage arrays are built to use the specified reliability mechanisms, e.g., RAID level mechanisms or the like. The one or more storage arrays that are built in the manner above are then associated with each other as part of a logical storage pool that includes volumes and filesystems for storage of data. The logical storage pool is associated with the user and constitutes the user's cloud storage device. It should be appreciated that while a single cloud storage device is visible to the user, it is actually composed of a plurality of physical storage devices that may be located in various storage systems at various locations but which are connected to a data network through which they may be utilized together.

As an example, consider a situation where a user of client computing device 310 logs onto the server 330 to establish a cloud storage device. The user chooses to have three 1 TB disk drives performing at 7200 RPMs with a RAID level of 5. In such a case, the cloud storage control system 331 may select disk drive 342 in storage system 340, disk drive 352 in storage system 350, and disk drive 362 in storage system 360 to be assigned to the user's cloud storage device (as represented by the dashed line in FIG. 3). These disk drives 342, 352, and 362 are of the type selected by the user and are therefore combined into a logical storage pool with the volumes, filesystems, and reliability mechanisms desired by the user to provide the cloud storage device.

As mentioned above, one of the major benefits of the illustrative embodiments is that the user is provided with the ability to specify the type, performance, and reliability of the physical storage devices that are to be used to create the user's cloud storage device. In known cloud storage device services or systems, the user is only able to specify the total storage capacity that the user wishes to have and is not guaranteed any level of performance. As a result, the performance of cloud storage devices using known cloud storage device services or systems is often less than desirable for the user.

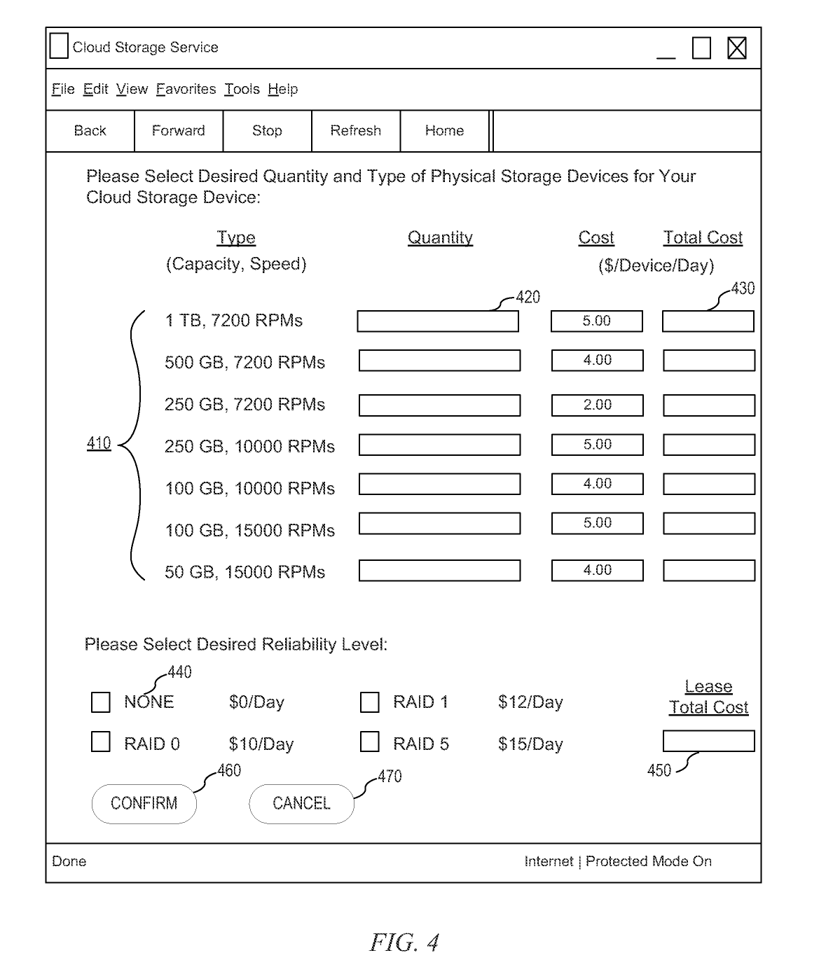

As mentioned above, the cloud storage service system of the illustrative embodiments provides user interfaces through which the user may specify the type and performance characteristics of the physical storage devices that are to be used to make up the cloud storage device. FIG. 4 is an example diagram of a user interface for selecting physical disks to be included in a cloud storage device in accordance with one illustrative embodiment. It should be appreciated that the user interface shown in FIG. 4 is only an example and is not intended to state or imply any limitation with regard to the content, arrangement, or composition of the user interfaces that may be used with the mechanisms of the present invention. To the contrary, many modifications to the depicted user interface may be made without departing from the spirit and scope of the illustrative embodiments and the present invention. For example, various other types of user interface elements, such as drop down menus, selectable virtual buttons, and the like may be used in conjunction with, or in replacement of, the elements shown in FIG. 4.

As shown in FIG. 4, the user interface includes a listing 410 of available physical storage device types from which a user can select. The listing 410 includes information about the storage capacity of the physical storage device type and one or more performance characteristics of the physical storage device type. For example, the storage capacity in TB, GB, MB, or the like may be displayed along with an indication of the RPMs of the physical storage device type. In addition, a lease cost for each device of the particular physical storage device type, per unit of time, is displayed so that the user can determine the cost/capacity/performance tradeoff. For example, the lease cost may be specified as $X/device/unit of time.

Next to the listing 410 is a set of user entry fields 420 into which a user may input a number of the corresponding physical storage device type the user wishes to include in their cloud storage device. A corresponding total lease cost may be calculated and output in fields 430 so that the user is apprised of the total cost of leasing the entered number of physical storage device.

In addition, various options of reliability mechanisms 440 may be displayed in the user interface. For example, various RAID levels may be specified in elements 440 with associated check boxes so that the user may check which reliability mechanism, if any, the user wishes to include in the cloud storage device. A corresponding cost for the reliability mechanism may also be displayed. In response to a user checking a box next to one of the reliability mechanisms, the cost of the reliability mechanism may be added to the total for all of the selected physical storage devices such that a final total lease cost 450 may be displayed for consideration by the user. User selectable buttons 460 and 470 may be provided for confirming the user's selections and thereby initiating the creation of the cloud storage device, or for canceling the operation.

In addition to selecting the number and type of physical storage devices directly, a user may input desired aggregate capacity and performance characteristics of the cloud storage device and the system will select an appropriate number and type of physical storage devices sufficient to provide the desired performance. For example, a user may specify total capacity in GB, aggregate throughput in MB/s, aggregate I/O operations per second (IOPS) and mean time to data loss (MTTDL). Using a table of performance characteristics of different device types, the system can calculate what number and type of physical storage devices are required to achieve the requested performance. The system can report the calculated configuration and its price to the user and allow the user to modify it.

In another illustrative embodiment, each user may exclusively rent or license a dedicated storage controller in addition to disks. In cases where the storage controller may be a performance bottleneck, this ensures that one user may not degrade the controller performance of another user. The provider may use a storage network connecting all disks to all controllers, allowing disks to be dynamically provisioned without any human intervention. The storage network may use Serial Attached SCSI (SAS), Fibre Channel, or Ethernet technology, for example, and may use zoning to maintain the security property that each user's controller only accesses disks that have been rented/licensed by that user. Hybrid embodiments are also possible, where some users share storage controllers and other users have dedicated controllers, or where some users share disks while other users have dedicated disks.

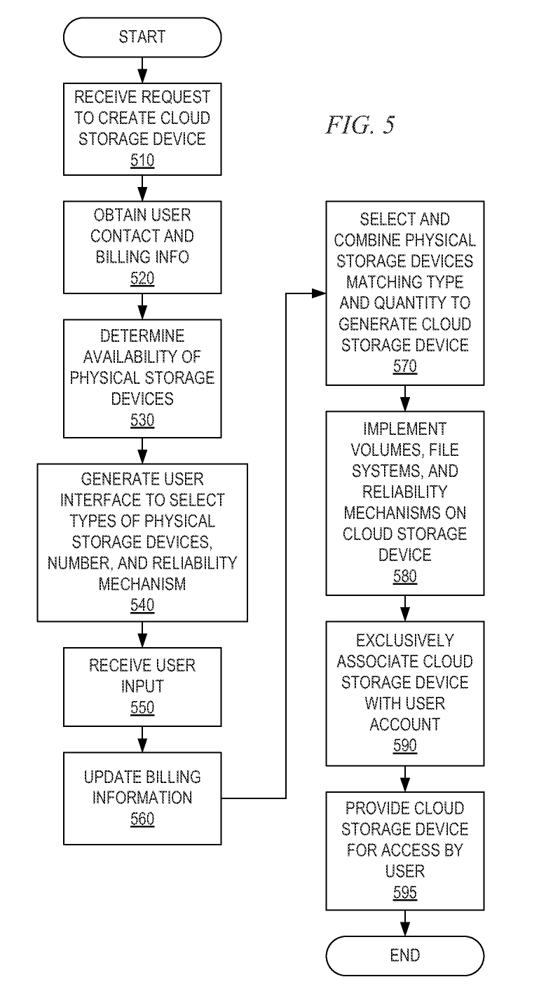

FIG. 5 is a flowchart outlining an example operation for establishing a cloud storage device in accordance with one illustrative embodiment. As shown in FIG. 5, the operation starts with a user submitting a request to create a cloud storage device via the user's client computing device (step 510). User contact and billing information are obtained and an account storing the collected information is created (step 520). A current availability of physical storage devices is determined based on information in a storage device registration data structure (step 530). Based on the current availability of physical storage devices, a user interface for specifying the type of physical storage devices, number of each type of physical storage device, reliability mechanisms, and the like, is provided to the user's client computing device (step 540).

A response from the user, via the user interface, is received that specifies the types of physical storage devices, number of each type of physical storage device, reliability mechanisms, and the like, that the user wishes to include in their cloud storage device (step 550). The billing information for the user's account is updated based on the selected type and number of physical storage devices and reliability mechanism, if any (step 560). Physical storage devices corresponding to the selected type and number are selected, combined into one or more storage arrays, which are combined into a pool of storage devices (step 570), and corresponding volumes, filesystems, and reliability mechanisms are implemented on the pool of storage devices (step 580). The pool of storage devices is associated with the user's account such that the physical storage devices in the pool of storage devices are exclusively associated with the user's cloud storage device (step 590). The user is then presented with a single virtual storage device, i.e. the cloud storage device, with which the user may store and retrieve data (step 595). The operation then terminates.

Thus, the illustrative embodiments provide mechanisms for creating and maintaining a cloud storage device that enables a user to have greater control over the types of physical storage devices used to create the cloud storage device. The user is able to specify the standardized type of physical storage devices to include as well as their level of performance. The user is further able to specify the particular number of these physical storage devices to include in the cloud storage device and is billed according to the number of physical storage devices per unit of time used by the user as part of the cloud storage device. The user is further able to specify reliability mechanisms to be applied to the cloud storage device's physical storage devices. As a result, the user is given greater control and insight into the tradeoff between storage capacity, performance, reliability, and cost than is presently known in cloud storage device services.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for creating a cloud storage device, comprising:
presenting a user interface for selecting a type of physical storage devices, from a plurality of possible physical storage devices, to include in the cloud storage device and a number of a selected type of physical storage devices to include in the cloud storage device;
receiving user input via the interface specifying the selected type of physical storage devices and the number of the selected type of physical storage devices;
generating a cloud storage device comprising the specified number of the selected type of physical storage devices; and
providing the cloud storage device for access by a client computing device associated with the user.

2. The method of claim 1, wherein the type of physical storage devices specifies a storage capacity of the physical storage devices and at least one performance characteristic of the physical storage devices.

3. The method of claim 2, wherein the at least one performance characteristic is at least one of revolutions per minute (RPMs), throughput, or input/output operations per second (IOPS).

4. The method of claim 1, wherein:
the user interface further provides mechanisms for selecting a reliability mechanism to be applied to physical storage devices of the cloud storage device,
the user input specifies at least one selected reliability mechanism to use with the physical storage devices of the cloud storage device, and
generating the cloud storage device further comprises generating the cloud storage device using the at least one selected reliability mechanism.

5. The method of claim 4, wherein generating a cloud storage device comprising the specified number of the selected type of physical storage devices comprises generating a pool of physical storage devices from one or more storage systems, wherein the pool of physical storage devices is comprised of a set of one or more storage arrays, and wherein the one or more storage arrays are comprised of a set of one or more physical storage devices of the selected type arranged according to the at least one selected reliability mechanism.

6. The method of claim 4, wherein the reliability mechanism is a Redundant Array of Independent Disks (RAID) level reliability mechanism.

7. The method of claim I, wherein the physical storage devices of the cloud storage device are exclusively assigned to the user and are not shared with other users.

8. The method of claim 1, further comprising:
billing the user for usage of the cloud storage device based on a price per number of physical storage devices of the selected type.

9. The method of claim 1, further comprising:
maintaining a data structure specifying a status of a global pool of physical storage devices, wherein the status indicates, for each physical storage device in the global pool of physical storage devices, whether the physical storage device is available to be assigned to a cloud storage device of a user, wherein generating the cloud storage device comprises selecting physical storage devices for inclusion in the cloud storage device based on the data structure.

10. The method of claim 1, wherein the user interface specifies, for each type of storage device in the plurality of types of storage devices, a cost per storage device per period of time such that a user may determine a tradeoff between cost and performance of the cloud storage device.

11-25. (canceled)
